(19) United States
(12) Patent Application Publication
(10) Pub. No.: US 2009/0263093 A1
(43) Pub. Date: Oct. 22, 2009

(54) LIGHT GUIDING ASSEMBLY

(75) Inventor: Jin-Ti Cao, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: SHENZHEN FUTAIHONG PRECISION INDUSTRY CO., LTD., ShenZhen City (CN); FIH (Hong Kong) Limited, Kowloon (HK)

(21) Appl. No.: 12/146,568

(22) Filed: Jun. 26, 2008

(30) Foreign Application Priority Data
Apr. 16, 2008 (CN) 200810301155.3

(51) Int. Cl. G02B 6/10

(52) U.S. Cl. 385/129

(57) ABSTRACT

A light guiding mechanism (20) for illuminating a keypad assembly of a portable electronic device is provided. The light guiding mechanism (20) includes a light guiding plate (22) and a shielding plate (24). The light guiding plate (22) having a peripheral wall (226). The shielding plate (24) having a frame (242) and defining a hole (244) for receiving the light guiding plate (22) therein, and the frame (242) surrounding the peripheral wall (226) of the light guiding plate (22)ss.

### CROSS-REFERENCE TO RELATED APPLICATIONS

This application is related to co-pending U.S. patent applications (Attorney Docket No. US20127), entitled “LIGHT GUIDING MECHANISM”, by Jin-Ti Cao et al. The application has the same assignee as the present application and has been concurrently filed herewith. The above-identified applications are incorporated herein by reference.

### BACKGROUND

1. Field of the Invention

The present invention relates to light guiding mechanisms and, particularly to a light guiding mechanism used in portable electronic devices.

2. Description of Related Art

Portable electronic devices usually include keypads for inputting information. When operating such portable electronic devices in a dark room, keys of the keypads need to be illuminated for the user to operate. Each key can be illuminated by a respective light source corresponding to the key. However, this type of keypad is expensive since many light sources are required.

A typical way to reduce the number of light sources is to use a light guiding member in the form of a transparent plate. A typical light guiding member includes an array of apertures. As each key is arranged to align with the corresponding aperture, and the keys are illuminated by the light guided by the light guiding member. However, bright areas of the light guiding member may appear where the light sources are disposed adjacent to the light guiding member. Thus, there is decreased illumination uniformity of the light guide plate, which increases the difficulty of producing a desirable uniform illumination for the keypad.

Therefore, there is room for improvement within the art.

### BRIEF DESCRIPTION OF THE DRAWINGS

Many aspects of a light guiding mechanism can be better understood with reference to the following drawings. These drawings are not necessarily drawn to scale, the emphasis instead being placed upon clearly illustrating the principles of the present light guiding mechanism. Moreover, in the drawings like reference numerals designate corresponding parts throughout the several views. Wherever possible, the same reference numbers are used throughout the drawings to refer to the same or like elements of an embodiment.

FIG. 1 is an isometric and assembled schematic view of a light guiding mechanism in accordance with an exemplary embodiment; and

FIG. 2 is an exploded view of the light guiding mechanism shown in FIG. 1.

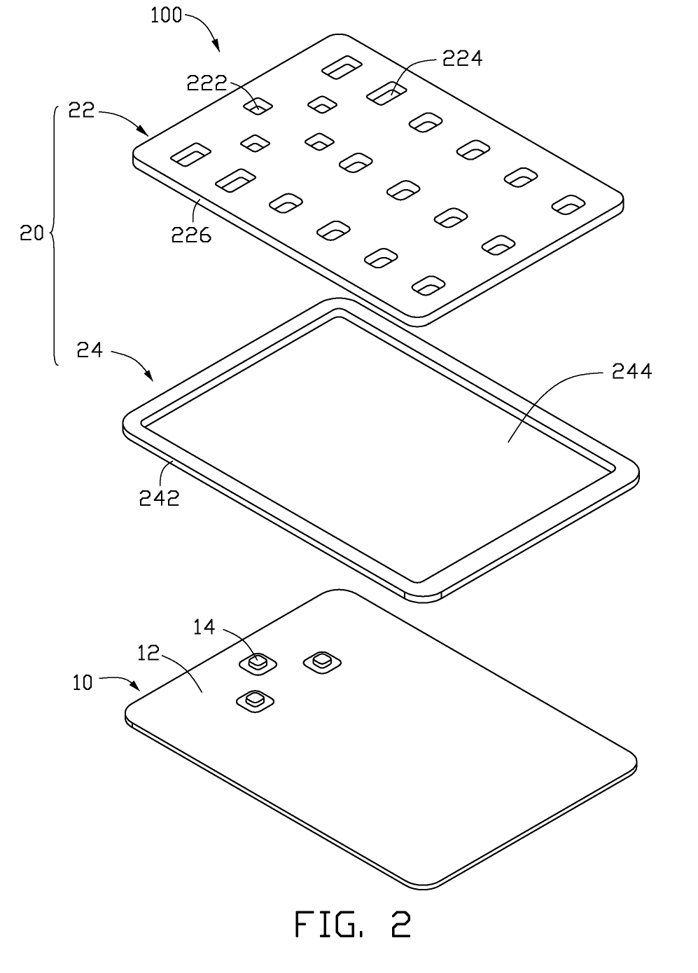

### DETAILED DESCRIPTION OF PREFERRED EMBODIMENTS

Embodiments will now be described in detail below and with reference to the drawings. The light guiding mechanism can be applied to an electronic device, for example, a mobile phone. Therefore, the light guiding mechanism is shown in the abstract, rather than associated with any particular electronic device.

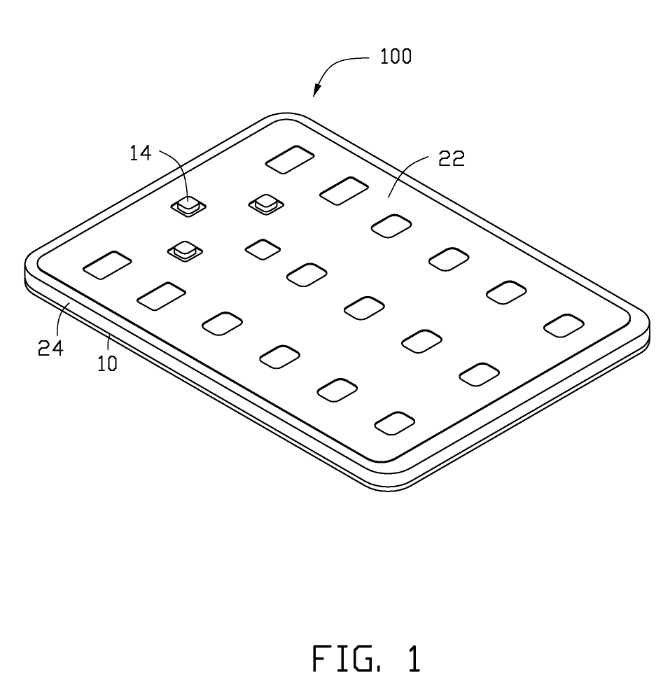

FIG. 1 shows a circuit board 10 and a light guiding mechanism 20. The light guiding mechanism 20 is disposed on the circuit board 10. The circuit board 10 is generally rectangular and includes a surface 12 facing the light guiding mechanism 20. The circuit board 10 has a plurality of light sources 14 on its surface 12. The light sources 14 may be light emitting diodes (LEDs). When the light sources 14 are placed within the light guiding mechanism 20, light generated by the light sources 14 can be guided to illuminate keys of a keypad assembly (not shown).

The light guiding mechanism 20 includes a light guiding plate 22 and a shielding plate 24. The light guiding plate 22 defines a plurality of first holes 222 and a plurality of second holes 224. The first holes 222 correspond to and accommodate the light sources 14 therein. The second holes 224 correspond to and accommodate the keys of the keypad assembly (neither shown). The light guiding plate 22 can be made of one or more materials selected from a group consisting of polyvinyl chloride (PVC), polycarbonate, polystyrene, and any other thermoplastic resins.

The shielding plate 24 includes a rectangular frame 242 defining a central hole 244. The chamber 244 has substantially the same shape as the light guiding plate 22, and has a size just slightly larger than the light guiding plate 22. The chamber 244 is configured (e.g., structured/arranged) for receiving the light guiding plate 22 therein, and the frame 242 surrounds a peripheral wall 226 of the light guiding plate 22. The shielding plate 24 can be made of an opaque material with a black color, e.g., the mixture of resin and carbon.

The frame 242 and the peripheral wall 226 can be integrally attached together by various means, such as adhesives or hot melt.

Because the frame 242 surrounds the peripheral wall 226 of the light guiding plate 22, unexpected light leaks, such as light emitted from the light sources 14 leaking through the peripheral wall 226, can be reduced. Thus, the brightness of the light guided by the light guiding plate 22 and the light guiding effect of the light guiding plate 22 are improved.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A light guiding mechanism, comprising:
a light guiding plate, the light guiding plate having a peripheral wall; and
a shielding plate having a frame and defining a hole for receiving the light guiding plate therein, and the frame wholly surrounding the peripheral wall of the light guiding plate to prevent light from leaking through the peripheral wall.

2. The light guiding mechanism as claimed in claim 1, wherein the shielding plate and the light guiding plate are attached to each other.

3. The light guiding mechanism as claimed in claim 1, wherein the frame and the peripheral wall is integrally attached together by hot melt.

4. The light guiding mechanism as claimed in claim 1, wherein the shielding plate is opaque.

5. The light guiding mechanism as claimed in claim 4, wherein the shielding plate is made opaque using an opaque material.

6. The light guiding mechanism as claimed in claim 3, wherein the light guiding plate is made of one or more thermoplastic resins selected from the group consisting of PVC (polyvinyl chloride), polycarbonate and polystyrene.

7. A light guiding mechanism for illuminating a keypad assembly of a portable electronic device, comprising:
a light guiding plate, the light guiding plate having a peripheral wall; and
a shielding plate having a frame and defining a hole for receiving the light guiding plate therein, and the frame wholly surrounding the peripheral wall of the light guiding plate to prevent light from leaking through the peripheral wall.

8. The light guiding mechanism as claimed in claim 7, wherein the shielding plate and the light guiding plate are attached to each other.

9. The light guiding mechanism as claimed in claim 7, wherein the frame and the peripheral wall is integrally attached together by hot melt.

10. The light guiding mechanism as claimed in claim 7, wherein the shielding plate is opaque.

11. The light guiding mechanism as claimed in claim 10, wherein the shielding plate is made opaque using an opaque material.

12. The light guiding mechanism as claimed in claim 10, wherein the light guiding plate is made of one or more thermoplastic resins selected from the group consisting of PVC (polyvinyl chloride), polycarbonate and polystyrene.
